(19) United States
(12) Patent Application Publication
(10) Pub. No.: US 2010/0111095 A1
(43) Pub. Date: May 6, 2010

(54) DATA TRANSFER

(75) Inventors: David Trossell, Dorset (GB); Lewis Hibell, Hampshire (GB)

Correspondence Address: BANNER & WITCOFF, LTD., 1100 13th STREET, N.W., SUITE 1200, WASHINGTON, DC, 20005-4051, US

(73) Assignee: Bridgeworks Limited, Dorset (GB)

(21) Appl. No.: 12/263,773

(22) Filed: Nov. 3, 2008

(51) Int. Cl. H04L 12/28; H04L 12/56

(52) U.S. Cl. 370/402; 370/401

(57) ABSTRACT

A bridging system, comprising bridges 3, 4 and network 5, is arranged to transfer data using TCP/IP or similar between a local Storage Area Network (SAN) 1 and a remote SAN 2. In one embodiment, the bridge 3 is arranged to transfer data from a plurality of ports 12-1˜12-n in a periodic sequence. While an acknowledgement from SAN 2 for data transferred from one port 12-1 data is awaited, further data can be transferred using one or more of the remaining ports 12-2˜12-n. In other embodiments, one or more parameters, such as number of ports, Receive Window Size etc., can be optimised using artificial intelligence (AI) routines in order to control the data transfer rate between the bridges 3, 4. The bridging system may be configured to perform a self-learning routine on installation and, in some embodiments, to compile and consult a knowledge base storing optimum configurations for transferring data packets having different attributes by simulating data transfers.

### FIELD OF THE INVENTION

The invention relates to a method and apparatus for transferring data.

### BACKGROUND OF THE INVENTION

The rate at which data can be transferred between network nodes using conventional methods can be limited by a number of factors. In order to limit network congestion, a first node may be permitted to transmit only a limited amount of data before an acknowledgement message (ACK) is received from a second, receiving, node. Once an ACK message has been received by the first node, a second limited amount of data can be transmitted to the second node. In Transmission Control Protocol/Internet Protocol (TCP/IP) systems, that limited amount of data relates to the amount of data that can be stored in a receive buffer of the second node and is referred to as a TCP/IP “window”.

In conventional systems, the size of the TCP/IP window may be set to take account of the round-trip time between the first and second nodes and the available bandwidth. The size of the TCP/IP window can influence the efficiency of the data transfer between the first and second nodes because the first node may close the connection to the second node if the ACK message does not arrive within a predetermined period. Therefore, if the TCP/IP window is relatively large, the connection may be “timed out”. Moreover, the amount of data may exceed the size of the receive buffer, causing error-recovery problems. However, if the TCP/IP window is relatively small, the available bandwidth might not be utilised effectively. Furthermore, the second node will be required to send a greater number of ACK messages, thereby increasing network traffic. In such a system, the data transfer rate is also determined by time required for an acknowledgement of a transmitted data packet to be received at the first node. In other words, the data transfer rate depends on the round-trip time between the first and second nodes.

The above shortcomings may be particularly significant in applications where a considerable amount of data is to be transferred. For instance, the data stored on a Storage Area Network (SAN) may be backed up at a remote storage facility, such as a remote disk library in another Storage Area Network (SAN). In order to minimise the chances of both the locally stored data and the remote stored data being lost simultaneously, the storage facility should be located at a considerable distance. In order to achieve this, the back-up data must be transmitted across a network to the remote storage facility. However, this transmission is subject to a limited data transfer rate. SANs often utilise Fibre Channel (FC) technology, which can support relatively high speed data transfer. However, the Fibre Channel Protocol (FCP) cannot be used over distances greater than 10 km, although a conversion to TCP/IP traffic can be employed to extend the distance limitation.

### SUMMARY OF THE INVENTION

Initial values for one or more parameters pertaining to data transfer between a first node and a second node may be obtained. Data can then be transferred from the first node to the second node via one or more connections between the first node and the second node in accordance with said parameters. An adjustment routine may be performed in order to obtain updated values of the one or more parameters based on performance of the data transfer.

In this manner, the first node may automatically adjust parameters associated with the data transfer during a transmission, in order to maintain a given level, or an optimum level, of performance. For instance, the node may be arranged to adjust one or more of the number of connections, Receive Window size, packet size and so on, based on measures such as a round-trip time between the first and second nodes, network speed, central processor unit (CPU) loading at the first and/or second node and so on. For instance, the one or more parameters may include the number of connections used to transfer the data from the first node to the second node, in which case the method may include adjusting the number of connections between the first node and the second node according to the updated values.

Example methods for obtaining initial values include obtaining values from a previous data transfer between the first and second nodes, from determining attributes of the data packets to be transferred and retrieving initial values corresponding to said attributes from a database. For instance, the adjustment routine may be performed for simulated data transfers between the first and second node for data packets having different attributes, and the database compiled from the updated values obtained from said adjustment routine during said simulations. Such simulations may be performed for a plurality of pairs of first and second nodes. For example, in a bridging system, a set of one or more simulations may be performed for a plurality of bridge pairings.

Such a method permits the installation of a node to be simplified. For example, a newly installed bridge in a bridging system between local storage area networks (SANs) can teach itself appropriate initial values, using simulations to compile a database of values, or arrive at suitable values for specific data transfer scenarios through iteration and self-adjustment, without requiring manual tuning of the parameters. Moreover, the method permits such a node to maintain a given, or optimum, level of performance by repeating the adjustment routine during data transfer.

The node may include a processor arranged to obtain the initial values and one or more outputs for transferring data to the second node via one or more connections in accordance with said parameters, wherein the processor is arranged to perform the adjustment routine.

The node may further include a memory. The memory may be arranged to store values of said one or more parameters obtained from a previous data transfer between the node and said destination node, so that they can be retrieved by the processor for use as initial values for subsequent data transfers. Alternatively, or additionally, a database of initial values corresponding to certain attributes of data packets may be stored in the memory, so that the processor can obtain the initial values by determining attributes of the data packets to be transferred and retrieving the relevant initial values from the database. The processor may be arranged to compile such a database from simulated data transfers between the node and one or more destination nodes.

Another method of transmitting a plurality of related data packets from a first node to a second node may include configuring a plurality of connections at the first node and transmitting a first batch of said data packets from the first node to the second node using a first one of said connections. The transmission of a second batch of data packets from the first node to the second node using a second one of said connections can be initiated before a determination is made as to whether or not the first batch has been received by said second node.

For instance, where the determination is based on whether a message relating to the first batch has been received from the second node, the transmission of the second batch of data packets can be initiated before such a message is expected to be received, in order to reduce delays and improve data transfer rate.

A plurality of connections may be used in a periodic sequence. The connections may be configured so that the time taken for each cycle of the sequence is related to the round trip time between the first and second nodes. For example, where the determination of whether the first batch of packets has been received is made based on the receipt or non-receipt of an acknowledgement (ACK) message from the second node, the first node may be arranged to transmit data via the second and subsequent connections, so that further batches of data packets can be transmitted without having to wait for an ACK message for the first batch to be received. In another example, the determination may be based on the receipt or non-receipt of a negative acknowledgement (NACK) message.

The method may include monitoring a rate of transfer of said batches between the first node and the second node and adjusting the number of connections in the sequence according to said transfer rate.

A node may include a transmitter operable to transmit to the destination node data packets having one of a plurality of assigned port numbers and a receiver operable to receive messages from the destination node. Such a node may be operable to transmit a first batch of said data packets using a first one of said port numbers and transmit a second batch of said data packets from the first node to the second node using a second one of said port numbers before determining whether said first batch has been received by the destination node, said determination being based on whether a first message, relating to said first batch, has been received from the destination node.

A system including one or more nodes as described above and one or more destination nodes may be provided. In such a system, the destination node or nodes may be remote data storage facilities. For instance, a bridging system may include such nodes as bridges between SANs, connected via an external network such as the Internet.

A computer program including instructions that, when executed by a processor cause the node to perform one of the above methods may be provided. Such a computer program may be stored on a computer-readable medium.

### BRIEF DESCRIPTION OF THE DRAWINGS

Embodiments of the invention will now be described with reference to the accompanying drawings, of which:

FIG. 1 depicts a system according to an embodiment of the present invention;

FIG. 2 depicts a node in the system of FIG. 1;

FIG. 3 is a flowchart of a method according to an embodiment of the present invention;

FIG. 4 depicts data transfer in the system of FIG. 1;

FIG. 5 is a flowchart of a method according to another embodiment of the invention;

FIG. 6 is a flowchart of a method according to yet another embodiment of the invention;

FIG. 7 is a flowchart of a parameter learn routine that forms part of the method of FIG. 6;

FIG. 8 is a flowchart of a scaling factor learn routine that forms part of the method of FIG. 6;

FIG. 9 is a flowchart of a β learn routine that forms part of the method of FIG. 6;

FIG. 10 is a flowchart of a data transfer method that can be performed after the method depicted in FIG. 6; and

FIG. 11 is a flowchart of a self-teaching method according to a further embodiment of the invention.

### DETAILED DESCRIPTION

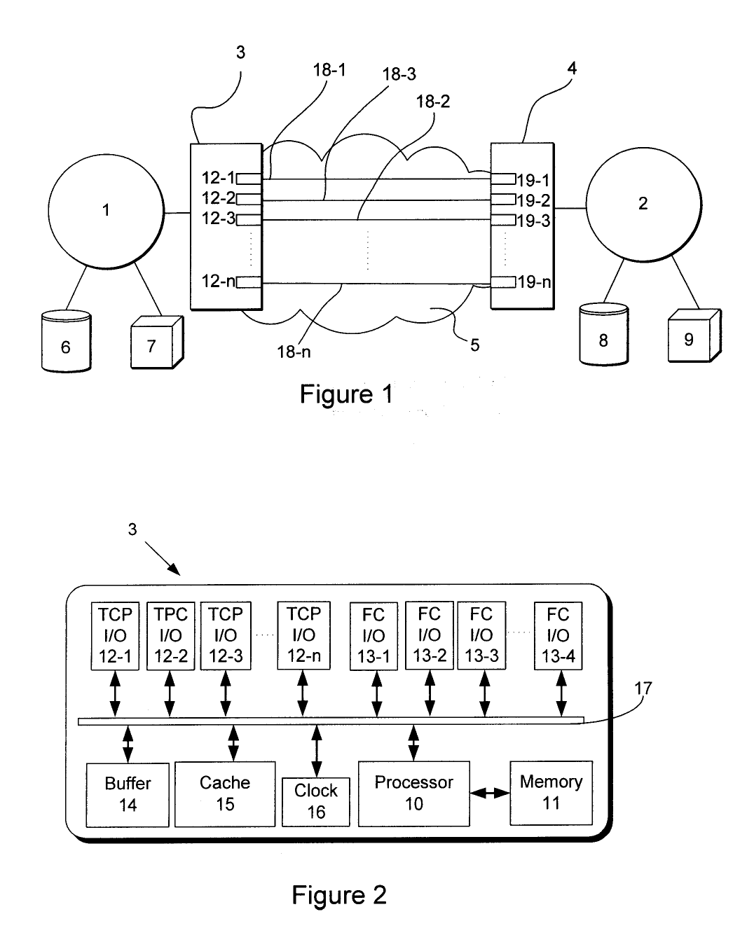

FIG. 1 depicts a system according to an embodiment of the invention. In this particular example, the system includes a local Storage Area Network (SAN) 1, a remote SAN 2. The remote SAN 2 is arranged to store back-up data from clients, servers and/or local data storage in the local SAN 1.

Two bridges 3, 4, associated with the local SAN 1 and remote SAN 2 respectively, are connected via a network 5. In this particular example, the network 5 is an IP network and the bridges 3 and 4 can communicate with each other using the Transmission Channel Protocol (TCP). The communication links between the bridges 3, 4 may include any number of intermediary routers and/or other network elements. Other devices 6, 7 within the local SAN 1 can communicate with devices 8 and 9 in the remote SAN 2 using the bridging system formed by the bridges 3,4 and network 5.

FIG. 2 is a block diagram of the local bridge 3. The bridge 3 comprises a processor 10, which controls the operation of the bridge 3 in accordance with software stored within a memory 11, including the generation of processes for establishing and releasing connections to other bridges 4 and between the bridge 3 and other devices 6, 7 within its associated SAN 1.

The connections between the bridges 3, 4 utilise I/O ports 12-1˜12-n, which may be TCP ports, physical ports or both. In this particular example, the I/O ports 12-1˜12-n are TCP ports. A plurality of Fibre Channel (FC) ports 13-1˜13-n may also be provided for communicating with the SAN 1. The FC ports 13-1˜13-n operate independently of, and are of a different type and specification to, the TCP ports 12-1˜12-n. The bridge 3 can transmit and receive data over multiple connections simultaneously using the TCP ports 12-1˜12-n and the FC Ports 13-1˜13-n.

A buffer 14 is provided for storing data for transmission by the bridge 3. A cache 15 provides large capacity storage while a clock 16 is arranged to provide timing functions. The processor 10 can communicate with various other components of the bridge 3 via a bus 17.

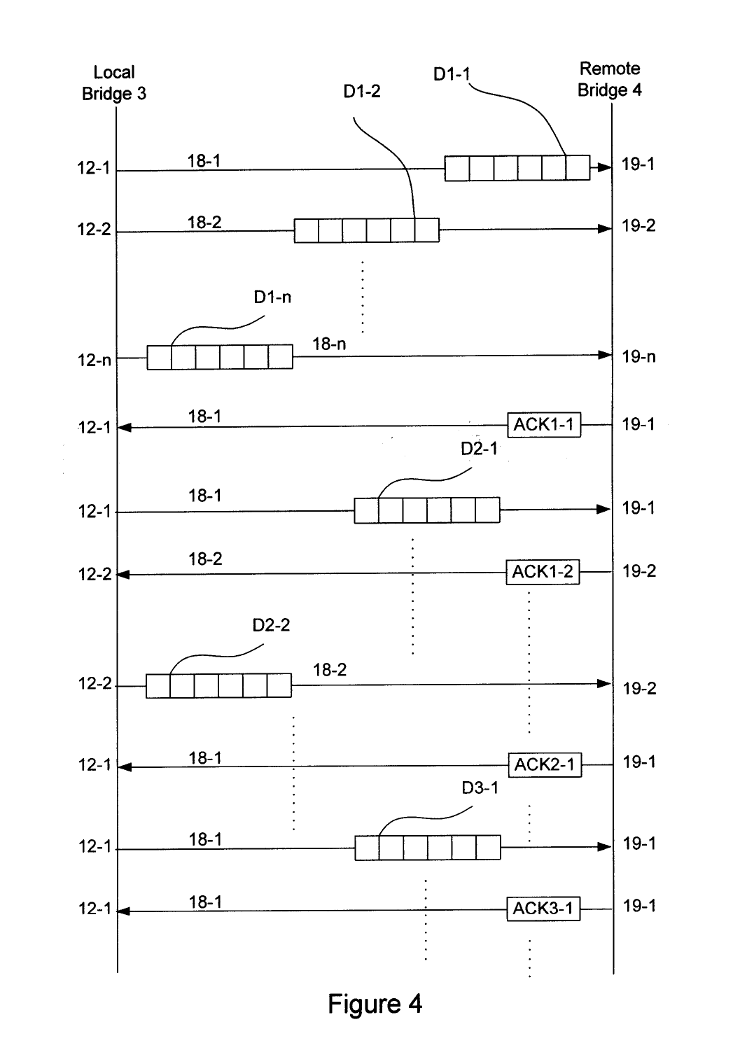

Referring to FIGS. 1 and 4, in order to transfer data, multiple connections 18-1˜18-n are established between ports 12-1-12-n of the bridge 3 and corresponding ports 19-1˜19-n of the remote bridge 4. In this manner, a first batch of data packets D1-1 can be transmitted from a first one of said ports 12-1 via a first connection 18-1. Instead of delaying any further transmission until an acknowledgement ACK1-1 for the first batch of data packets to be received, further batches of data packets D1-2 to D1-n can be transmitted using the other connections 18-b˜18-n. Once the acknowledgement ACK1-1 has been received, a new batch of data packets D2-1 can be sent to the remote bridge 4 from the first port 12-1, via the first connection 18-1, starting a repeat of the sequence of transmissions from ports 12-1˜12-n and connections 18-1˜18-n. Each remaining port 12-1˜12-n transmits a new batch of data packets D2-2 once an acknowledgement for the previous batch of data packets D1-2 sent via the corresponding connection 18-1˜18-n is received. In this manner, the rate at which data is transferred need not be limited by the round trip time between the bridges 3, 4.

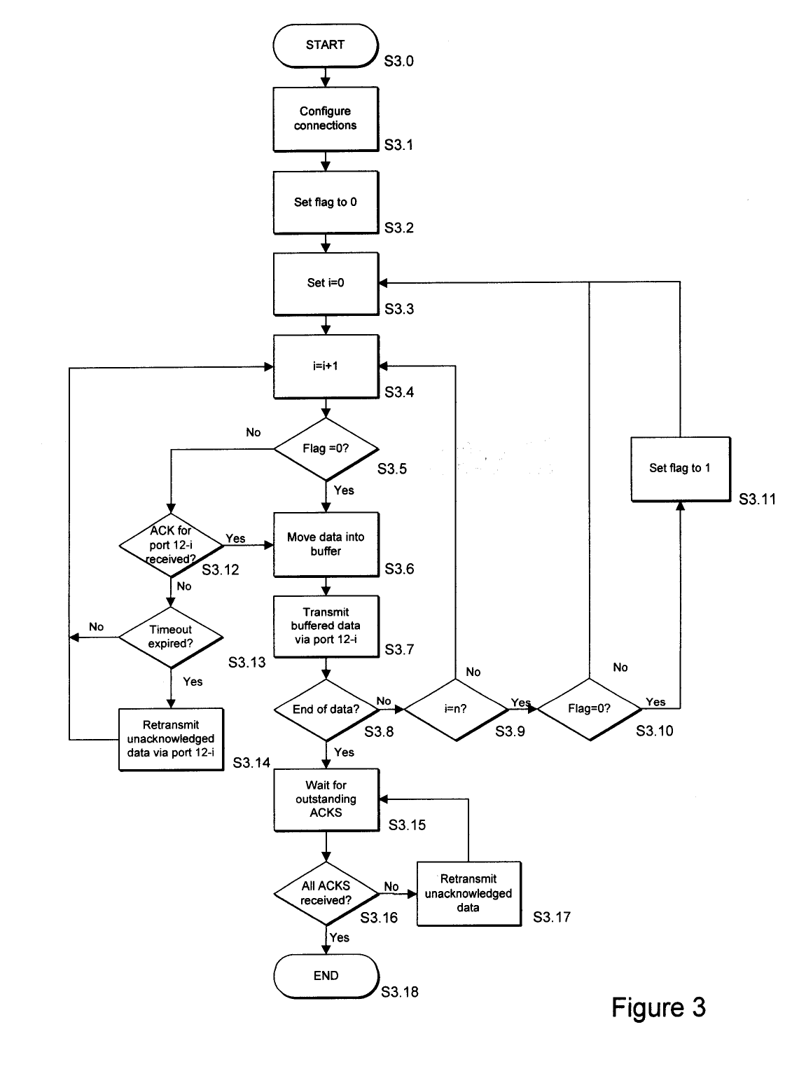

A method of transmitting data from the bridge 3 to the remote bridge 4, according to a first embodiment of the invention, will now be described with reference to FIGS. 3 and 4.

Starting at step s3.0, the bridge 3 configures n connections 18-1˜18-n between its ports 12-1˜12-n and corresponding ports 18-1˜18-n of the remote bridge 4 (step s3.1).

Where the bridge 3 is transferring data from the SAN 1, it may start to request data from other local servers, clients and/or storage facilities 6, 7, which may be stored in the cache 15. Such caches 15 and techniques for improving data transmission speed in SANs are described in U.S. patent application Ser. No. 11/637,195 (Publication no. US 2007/0174470 A1), the contents of which are incorporated herein by reference. Such a data retrieval process may continue during the following procedure.

As described above, the procedure for transmitting the data to the remote bridge 4 includes a number of transmission cycles using the ports 12-1˜12-n in sequence. A flag is set to zero (step s3.2), to indicate that the following cycle is the first cycle within the procedure.

A variable i, which will identify a port used to transmit data, is set to 1 (steps 3.3, 3.4).

As the procedure has not yet completed its first cycle (step s3.5), the bridge 3 does not need to check for acknowledgements of previously transmitted data. Therefore, the processor 10 transfers a first batch of data packets D1-1 to be transmitted into the buffer 14 (step s3.6). If the efficiency of the data transfer is to be maximised, the amount of data to be transmitted should correspond to the size of the TCP window. The buffered data packets D1-1 are then transmitted via port 12-i which, in this example, is port 12-1 (step s3.7).

As there remains data to be transmitted (step s3.8) and not all the ports 12-1˜12-n have been utilised in this cycle (step s3.9), i is incremented (step s3.4), in order to identify the next port and steps s3.5-s3.9 ate performed to transmit a second batch of data packets D1-2 using port 12-i, i.e. port 12-2. Steps s3.4-s3.9 ate repeated until batches of data packets D1-1 to D1-n has been sent to the remote bridge 4 using each of the ports 12-1˜12-n.

As the first cycle has now been completed (step s3.10), the flag is set to 1 (step s3.11), so that subsequent data transmissions are made according to whether or not previously transmitted data has been acknowledged.

Subsequent cycles begin by resetting i to 1 (steps s3.3, s3.4). Beginning with port 12-1, it is determined whether or not an ACK message ACK1-1 for the batch of data packets D1-1 most recently transmitted from port 12-1 has been received (step s3.12). If an ACK message has been received (step s3.12), a new batch of data packets D2-1 is moved into the buffer 14 (step s3.6) and transmitted (step s3.7). If the ACK message has not been received, it is determined whether the timeout period for port 12-1 has expired (step s3.13). If the timeout period has expired (step s3.13), the unacknowledged data is retrieved and retransmitted via port 12-1 (step s3.14).

If an ACK message has not been received (step s3.12) but the timeout period has not yet expired (step s3.14), no further data is transmitted from port 12-1 during this cycle. This allows the transmission to proceed without waiting for the ACK message for that particular port 12-1 and checks for the outstanding ACK message are made during subsequent cycles (step s3.12) until an ACK is received and a new batch of data packets D2-1 transmitted using port 12-1 (steps s3.6, s3.7) or the timeout period expires (step s3.13) and the batch of data packets D1-1 is retransmitted (step s3.14).

The procedure then moves on to the next port 12-2, repeating steps s3.4, s3.5, s3.12 and s3.7 to s3.9 or steps s3.4, s3.5, s3.12, s3.13 and s3.14 as necessary.

Once data has been newly transmitted using all n ports (step s3.9, s3.10), i is reset (steps s3.3, s3.4) and a new cycle begins.

Once all the data has been transmitted (step s3.8), the processor 10 waits for the reception of outstanding ACK messages (step s3.15). If any ACKs are not received after a predetermined period of time (step s3.16), the unacknowledged data is retrieved from the cache 15 or the relevant element 6, 7 of the SAN 1 and retransmitted (step s3.17). The predetermined period of time may be equal to, or greater than, the timeout period for the ports 12-1˜12-n, in order to ensure that there is sufficient time for any outstanding ACK messages to be received.

When all of the transmitted data, or an acceptable percentage thereof, has been acknowledged (step s3.16), the procedure ends (step s3.18).

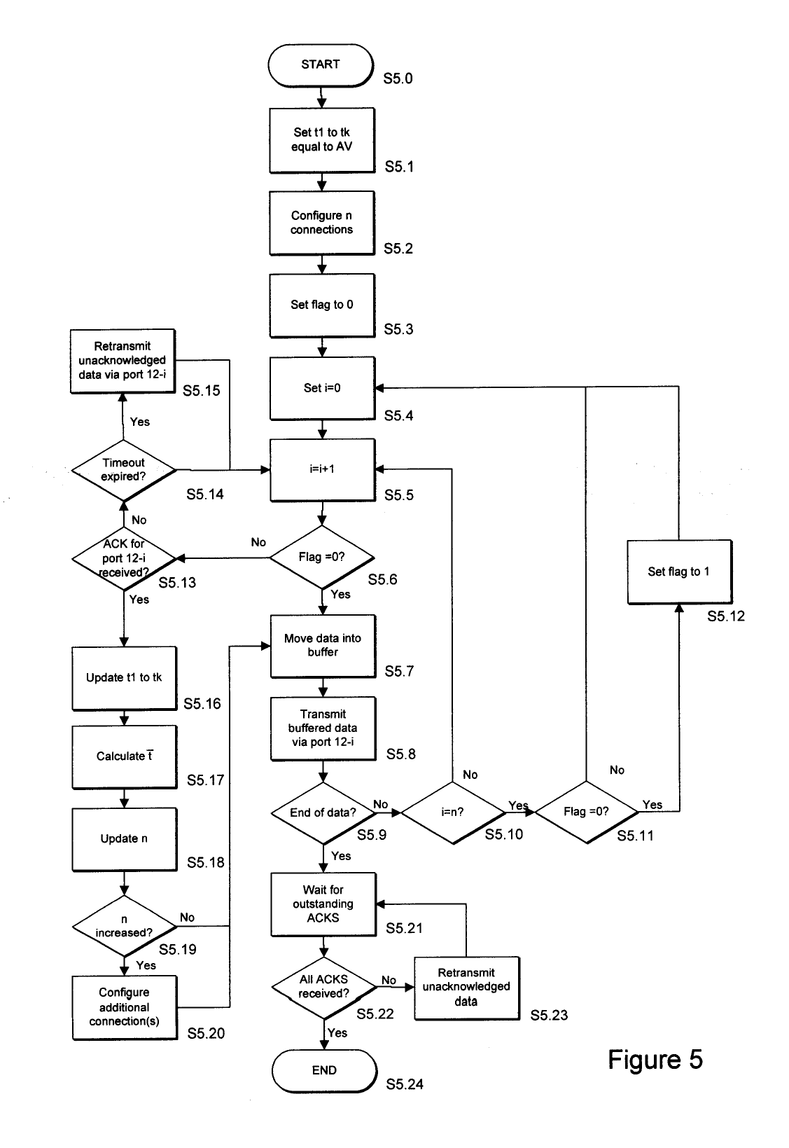

FIG. 5 depicts a method according to another embodiment of the invention, that can be performed by the bridge 3 of FIG. 2. The procedure of FIG. 5 differs from that of FIG. 3 in that the processor 10 can adjust the number of ports n within each cycle according to the round trip time between the bridges 3, 4.

Starting at step s5.0, the processor 10 initialises an array of k variables t1 to tk to a particular value AV (step s5.1). During the data transmission of t1 to tk will be used to indicate the k most recent round trip times, based on the time between the transmission of a batch of data packets D1-1 and the receipt of the corresponding ACK message ACK1-1. The value of k needs to be low enough so that t̅, which represents an average of t1 to tk, can respond to long term changes in network conditions that affect the round trip time. However, k also needs to be high enough so that the t̅ is not overly influenced by the time taken to receive any individual one of the ACK messages. For instance, in an arrangement where ten ports 12-1˜12-10 are provided, that is, where n=10, k could be set to 30, so that the average round trip time t̅ is calculated over three cycles. The initial values of t1 to tk, AV, may be a default value or a value determined by measuring an initial round trip time between the bridges 3, 4, using a “ping” function or similar.

The processor 10 then configures the ports 12-1˜12-n to be used and establishes corresponding connections 18-1˜18-n to the respective ports 19-1˜19-n of the remote bridge 4 (step s5.2). The number of ports n may be a default number or calculated by the processor based on AV. In the latter case, a relatively high value for AV will result in a relatively high value for n. For example, n could be calculated based on the following equation:

$$n = \frac{AV}{2} ( \frac{network speed}{packet size} ) \qquad [ 1 ]$$

The steps of the first cycle of the transmission procedure, steps s5.3 to s5.12 correspond to steps s3.2 to s3.11 described above, and so a detailed discussion of these steps is omitted.

Subsequent cycles of the transmission procedure begin by re-initialising i (steps s5.4, s5.5). i is now equal to 1, indicating port 12-1. As the flag has been set to 1 in step s5.12 (step s5.6), the processor 10 checks whether an ACK message ACK1-1 for the most recent batch of data packets D1-1 sent from port 12-1 has been received (step s5.13).

If an ACK message ACK1-1 has not been received (step s5.13) and the timeout period for the port 12-1 has expired (step s5.14), the corresponding data packets D1-1 are retrieved, transferred into the buffer 14 and retransmitted using port 12-1 (step s5.15). i is incremented to 2 (step s5.5) and the procedure moves on to the next port 12-2.

If an ACK message ACK1-1 has not been received (step s5.13) and the timeout period for the port 12-1 has not expired (step s5.14), no further data is transmitted from port 12-1 during this cycle. One or more checks for the outstanding ACK message are made during subsequent cycles (step s5.13) until an ACK is received and a new batch of data packets D2-1 can be transmitted using port 12-1, as described below, or until the timeout period expires (step s5.14) and the batch of data packets D1-1 is retransmitted (step s5.15). If the ACK message ACK1-1 has been received (step s5.13), variables t1 to tk are updated (step s5.16). For instance, the array may be updated using a first-in, first-out principle, so that the oldest value tk is discarded, the remaining values rewritten so that tk=tk-1, tk-1=tk-2. The newest value, determined by the time elapsed between the transmission of the batch of data packets D1-1 and the reception of the corresponding ACK message ACK1-1, ACK2-1, is stored as t1. The average round trip time t̅ is then calculated based on the updated values t1 to tk (step s5.17). A new value of n is calculated, based on the updated value of t̅ (step s5.18). If n has increased to n′ (step s5.19), then the processor 10 configures an additional connection 18-n between an extra port 12-n of the bridge 3 and a corresponding port 19-n of remote bridge 4 (step s5.20). The extra port 12-n will come into use at the end of the current cycle (step s5.10 and so on). The processor 10 then moves the next batch of data packets D2-1 into the buffer 14 (step s5.7) and transmits them (step s5.8), before moving onto the next port 12-2 (steps s5.9, s5.10, s5.5 and so on) until i=n and the current cycle is completed.

The transmission cycles continue until all of the data has been transmitted (step s5.21). The processor 10 then waits for the remaining ACK messages to be received (step s5.22), retransmitting any data that has not been acknowledged by the remote bridge 4 (step s5.23) before the timeout periods for the ports 12-1˜12-n has expired.

Once all the data, or an acceptable percentage of the data, has been acknowledged (step s5.22), the procedure ends (step s5.24).

It should be noted that, each set of ports 12-1˜12-n, 13-1˜13-n, 19-1˜19n depicted in FIGS. 1 and 2 need not include n physical ports, since it is possible to provide multiple connections using one physical port. In other words, the bridge 3 may provide connections 18-1˜18-n using m physical ports, where m is a number between 1 and n.

The method of FIG. 5 provides automatic adjustment of the number of ports 12-1˜12n used to transmit data between the bridges 3, 4. Those skilled in the use of TCP/IP and other such protocols will understand there are many configurable parameters that can be adjusted in addition to, or instead of, the number of ports n, in order to improve the performance between nodes on a network. For data transfer operations utilising the TCP/IP protocol, such parameters could include the packet size or the Receive Window Size. Other parameters that could be adjusted or optimised include network speed, CPU loading of the bridge 3 and memory loading of the bridge 3. The method shown in FIG. 5 could be modified to increase and/or decrease other parameters to optimise the data transfer rate, in addition to, or instead of, adjusting the number of ports n. For instance, a method could be devised to find a balance between the number of ports n and the packet size to provide a given level of performance.

It can take a considerable time and skill to manually tune such parameters.

Moreover, in order to the performance of the bridging system is maintained, this process must be undertaken at regular intervals, as the network conditions between nodes can vary over time.

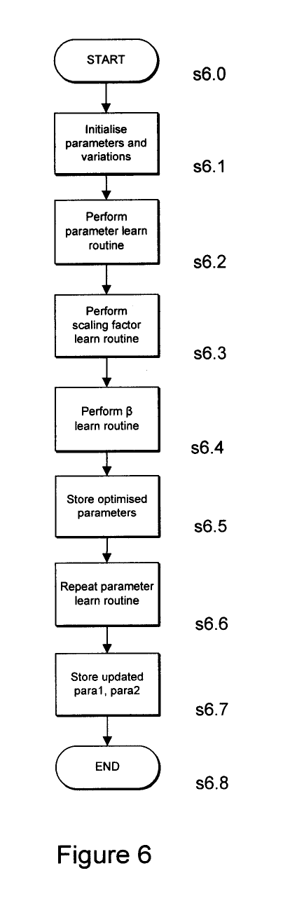

FIG. 6 depicts a method according to yet another embodiment of the invention that can be performed by the bridge 3 of FIG. 1. The procedure of FIG. 6 differs from that of FIGS. 3 and 5 in that the processor 10 can perform a self-teaching process to determine and, subsequently, to adjust any number of parameters in order to provide a given level of performance without requiring manual intervention.

While it is possible for such a method to adjust one or more parameters for the purposes of describing this process, an embodiment will be described in which only two parameters, para1, para2, are monitored and adjusted. In this particular example, the two parameters are the number of ports and the Receive Window Size.

Starting at step s6.0, when the bridge is first installed the bridge 3 enters a self-teaching routine to find the optimised settings for each parameter.

Firstly, the values of the two parameters para1, para2, a scaling factor, a β parameter are initialised by setting them to default values (step s6.1). Respective variation values for each of these parameters, Δ1, Δ2, Δsf, Δβ are also set to default 20 values. As described hereinbelow, the sizes of the variation values Δ1, Δ2, Δsf, Δβ depend on the scaling factor, while the optimisation conditions, which determine when the learning routine will stop, depend on β.

The processor 10 then performs a parameter learn routine (step s6.2), a scaling factor learn routine (step s6.3) and a β learn routine (step s6.4) in order to determine values for para1 and para2 for optimised data transfer between bridge 3 and bridge 4. The optimised values for para1, para2, the scaling factor and β obtained from the learn routines (steps s6.2, s6.3, s6.4) are then stored (step s6.5).

Optionally, the parameter learn routine can be repeated (step s6.6) using the newly obtained values for the scaling factor and β, to improve the optimisation of the parameters para1, para2. Updated values for the parameters para1, para2 are then stored (step s6.9).

The self-teaching routine, and the installation of the bridge 3, is then complete (step s6.8).

The bridge 3 can be arranged to retrain itself by repeating steps s6.2 to s6.4 or steps s6.2 to s6.7 periodically, so that the stored values of the parameters para1, para2, scaling factor and β are updated on a regular basis.

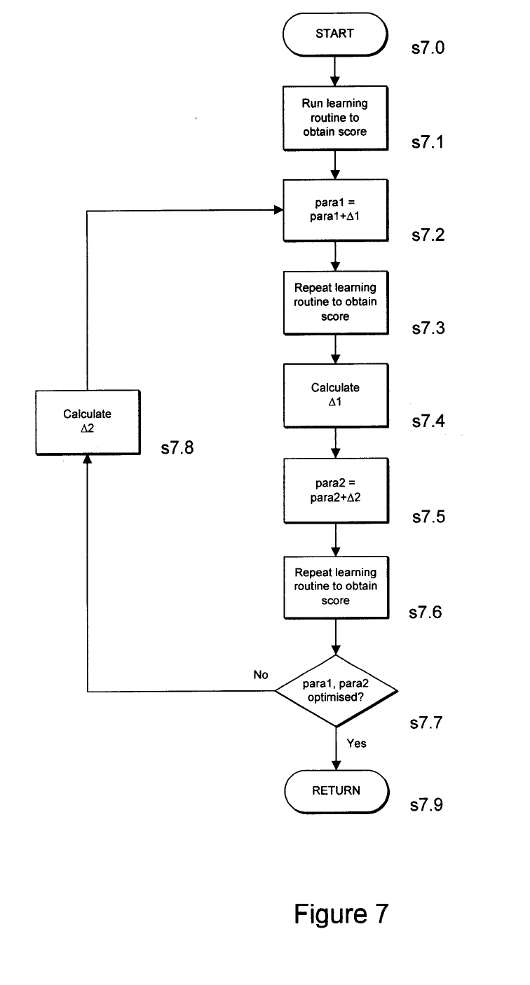

The parameter learn routine, scaling factor learn routine and β learn routine will now be described in detail, with reference to the flowcharts of FIGS. 7, 8 and 9 respectively.

The processor 10 performs a test, referred to as a self-learning routine, to obtain an initial performance figure or score (step s7.1) based on current values of para1 and para2. The first parameter, para1, is then updated by adding to it variation Δ1 (step s7.2). The value of Δ1 is refined during successive iterations of the learning routine, becoming smaller as the value of para1 approaches its optimised value. The self-learning routine is repeated and a new score obtained (step s7.3). An updated value of Δ1 is then calculated (step s7.4) using the formula:

$$updated value of Δ 1 = \frac{\begin{matrix}change in scores \times \\ scaling factor\end{matrix}}{current value of Δ 1} \qquad [ 2 ]$$

The second parameter (para2) is now changed by adding the current values of para2 and Δ2 together (step s7.5) and a new performance score is obtained (step s7.6).

The score is then tested to see if an optimum performance criterion has been met (step s7.7), using the following formula:

$$\frac{100}{score} \times {\sum }_{i = 1}^{{N}_{p} β} \vert {Δ}_{i} \vert < 1 \% \qquad [ 3 ]$$

where Nₚ is the number of Parameters and Δᵢ is the change in score in the i^{th} iteration before the current one.

As shown by equation [3], the determination that the performance of the bridging system has been optimised depends on the value of β.

If the optimum performance criterion has not been met (step s7.7) and another iteration is required in order to optimise para1 and para2, a new value of Δ2 is calculated using the following formula (step s7.8)

$$updated value of Δ 2 = \frac{\begin{matrix}change in scores \times \\ scaling factor\end{matrix}}{current value of Δ 2} \qquad [ 4 ]$$

and another training cycle (steps s7.2 to s7.7) is performed.

As shown by equations [2] and [4], the values of the variations Δ1 and Δ2 thus depend on the scaling factor. In other words, the scaling factor can influence the rate at which the self-learning routine arrives at an optimised value of para1 and para2. By permitting para1 and/or para2 to be changed by a relatively large variation Δ1, Δ2 can result in the optimised value for a parameter para1, para2 being found more quickly. However, the use of large variations Δ1, Δ2 may be counter-productive as it may cause the values of para1 and/or para2 to “overshoot” or “miss” their optimised value during initial iterations of the self-learning routine.

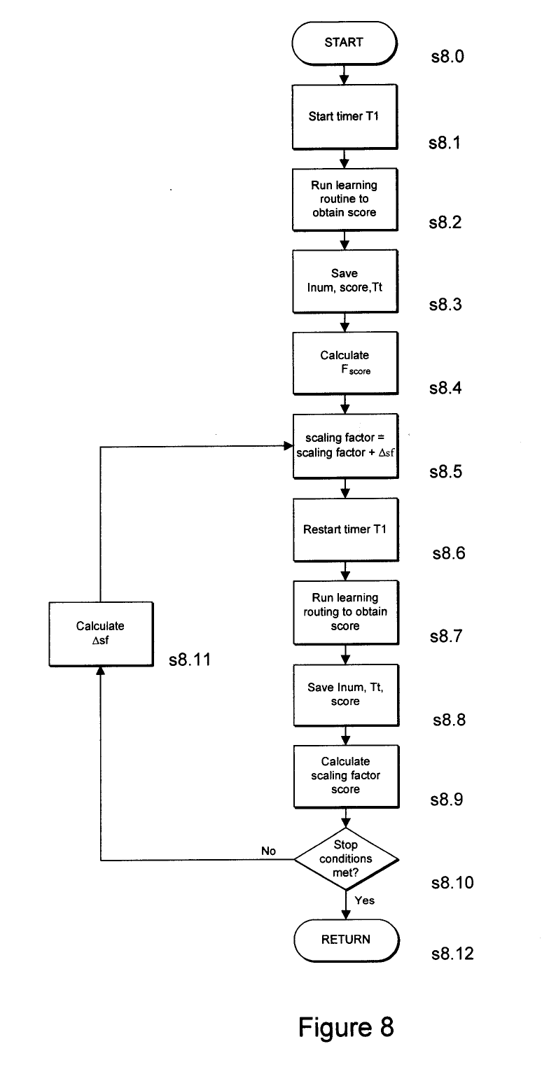

If the optimum performance criterion has been met (step s7.7), the learn process is completed (step s7.9).Referring now to FIG. 8, starting at step s8.0, a procedure for calculating the scaling factor begins by starting a timer T₁ (step s8.1) and running a learning routine to obtain a score relating to the optimisation of the current value of the scaling factor (step s8.2).

In step s8.3, the score, the number of iterations Iₙᵤₘ and the time T_{T} required to complete the learning routine are saved. The Scaling Factor Score value F_{score} is then calculated (step s8.4) using the following calculation function:

F_{score}=F(−T_{T},Score,Iₙᵤₘ [5]

The scaling factor and its variation Δsf are then added together (step s8.5). If the scaling factor learn routine is being performed for the first time, Δsf is first assigned an initial default value for this step.

The timer T1 is then reinitialised and restarted (step s8.6), the learning routine is performed again (step s8.7). The number of iterations Iₙᵤₘ and time Tt required to complete the learning routine and the maximum score for the most recent learning routine are saved (step s8.8) and the scaling factor score F_{score} is recalculated using the above formula (step s8.9). The process now assesses the results to determine whether the following stop condition for the scaling factor learn routine has been met (step s8.10):

$$\begin{matrix}m \geq 5 ; \\ and & [ 6 ] \\ \frac{100}{{F}_{score}} \times {\sum }_{i = 1}^{5} \vert {Δ}_{{Fscore}_{i}} \vert < 1 \% & [ 7 ]\end{matrix}$$

where m is the total number of performances of the learning routine (steps s8.2 & s8.7) and Δ_{FScorei} is the change in score in the ith learning routine performed before the most recent learning routine.

If the stop condition is not met (step s8.10), the scaling factor is adjusted by the current value of the variation Δsf (step s8.11) and steps s8.5 to s8.10 are repeated. If the stop condition is met, the scaling factor learn routine ends (step s8.12).

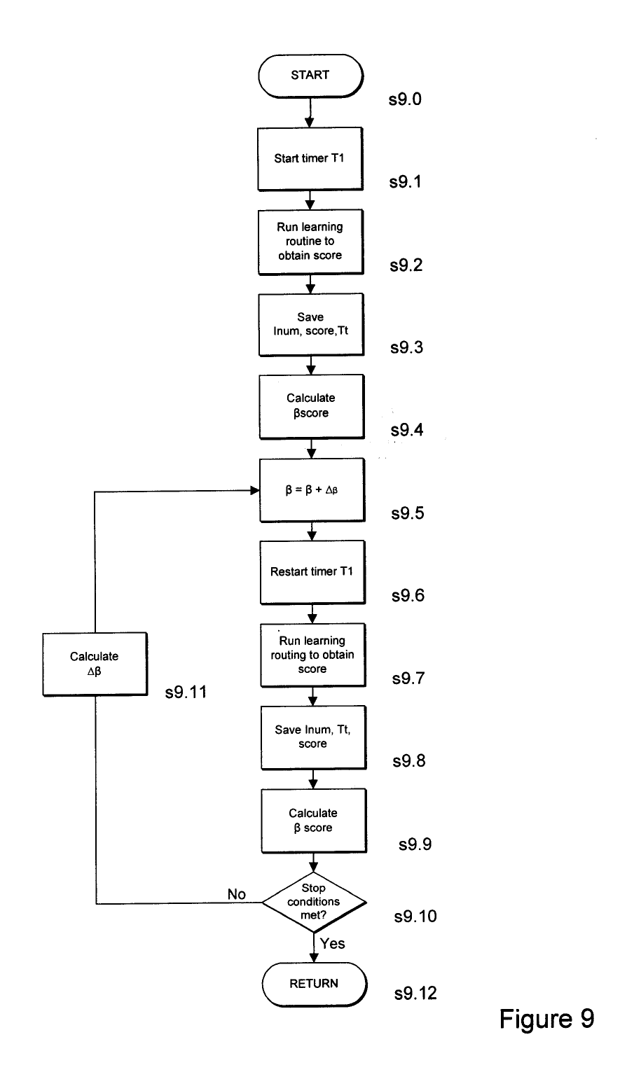

Referring now to FIG. 9 and starting at step s9.0, the β learn routine begins by starting a timer T1 (step s9.1).

A learning routine for β is performed in order to obtain a score (step s9.2). The number of iterations Iₙᵤₘ and the time Tt required to complete the learning routine are saved, together with the maximum score (step s9.3) and a value β_{score} is calculated (step s9.4) using the following formula:

β_{score}=F(−T_{T}, Score, Iₙᵤₘ) [8]

β is then adjusted by adding to it the current value of Δβ. If the learning routine is being performed for the first time, Δβ may be first assigned an initial default value before being added to β.

The timer T1 is then restarted (step s9.6) and the learning routine repeated (step s9.7) for to obtain a score based on the updated value of β.

Once the learning routine (step s9.7) has run to its conclusion, the number of iterations Iₙᵤₘ and the time Tt required to complete the learning routine is saved, along with the maximum score, and β_{score} is recalculated using the above formula.

The processor 10 then determines whether process stop conditions for the β learn routine have been met (step s9.10), based on the following criteria:

$$\begin{matrix}m \geq 5 ; \\ and & [ 9 ] \\ \frac{100}{{β}_{score}} \times {\sum }_{i = 1}^{5} \vert {Δ}_{{βscore}_{i}} \vert < 1 \% & [ 10 ]\end{matrix}$$

where m is the number of times the β learning routine (steps s9.2, s9.7) has been performed, β_{score i} is the change in score in the ith iteration of the self-learning routine performed before the most recent one.

If the stop conditions have not been met (step s9.10), Δβ is calculated (step s9.11) and steps s9.5 to s9.10 are repeated.

If the stop conditions are met (step s9.10), the β learn routine ends (step s9.11).

In different network topologies where there are more than two bridges communicating with each other, the initial self-teaching process of FIG. 6 is performed for each bridge pairing. These individual parameters applicable to each bridge pairing are stored in the bridge memory 11 for future use when communicating with said bridge.

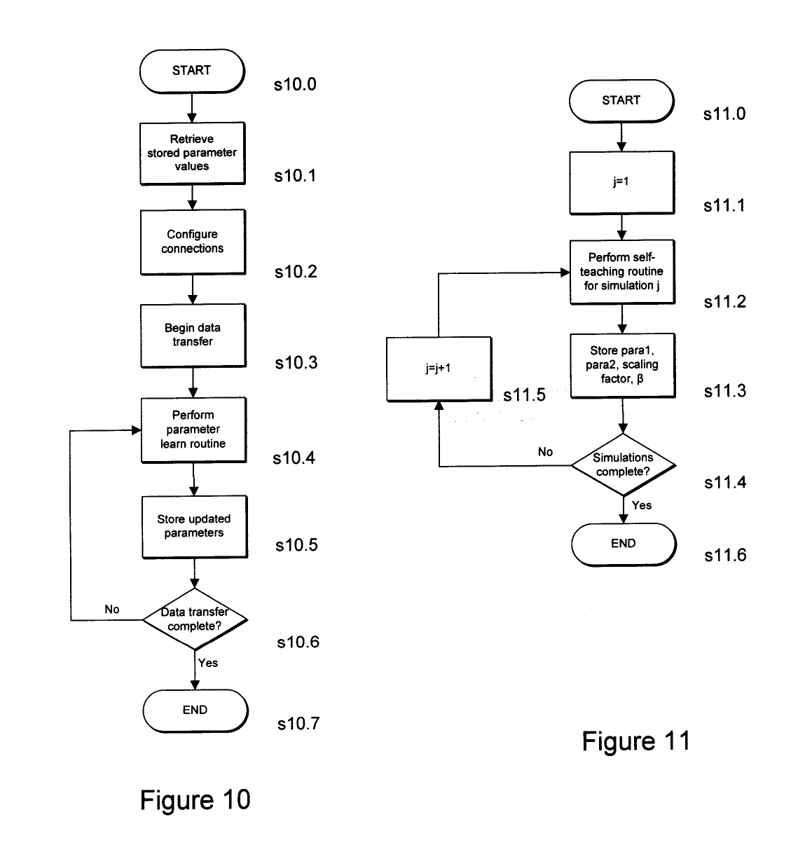

During normal data transmissions it is possible for certain parameters or conditions of the network 5 to alter, such as the delay time between transmission, packet loss and the ACK signal returning to that calculated in during the initial learn process, such that the parameters para1, para2 will require adjustment. As shown in FIG. 10, starting at step s10.0, a data transfer process will start by retrieving stored values for para1, para2, the scaling factor, β and, optionally, their respective variations (step s10.1). The bridge 3 will then configure n connections 18-1˜18n to the remote bridge 4 via ports 12-1˜12n in accordance with the retrieved parameters, para1, para2 (step s10.2) and begin the data transfer (step s10.3). In order to maintain performance, the processor 10 will, in addition to handling the data transmission, repeat the parameter learn routine of steps s7.1 to s7.7 periodically to obtain updated optimised values for the parameters para1, para2 (step s10.4) using the stored optimised parameters as an initial starting point. A set of updated optimised parameters para1, para2 are then calculated and stored in the bridge memory 11 (step s10.5) for use during the data transmission. Once the data transfer is complete (step s10.5, s10.6), the stored values, para1, para2, may continue to be updated periodically and/or during subsequent data transmissions.

FIG. 10 depicts a method of data transfer by a bridge 3 that has performed the self-teaching method of FIG. 6. Starting at step s10.0, the bridge 3 retrieves the parameter values that were stored at step s6.5 or s6.7.

In another embodiment of the invention, in order to alleviate delay caused by the initial setup of connections between the bridges 3, 4 and/or other bridges, the organisation of the connections and/or initial parameter values can be ascertained from the initial packets of a data transfer stream. The initial configuration of the connections and/or initial parameter values would be obtained from a simulation database that derives its parameters from network response, line capacity and packet loss factors.

For example, when a packet to be transmitted by the bridge 3 is received and cached, the optimum number of connections for that “type” of packet can be determined, based on data obtained from previous data transfers. The packet type can be indicated by a combination of stream attributes. The attributes may be external to the packet contents, such as size, source, destination, number of packets to be sent, data flow rate, time of day and age, or internal to the packet, such as user, application and/or device type.

In order to effectively analyse the incoming packets without slowing the response returned to an initiator in SAN 1, the system incorporates a Command Cache, which returns an “auto-good” to the initiator. Such a cache is described in our co-pending U.S. patent application Ser. no. 11/637,195.

The ability to determine the optimum setup for a specific packet type is achieved through the use of a Machine Learning System. An example method, in which the bridging system initially teaches itself the most efficient way of transmitting packets with different attributes, is shown in FIG. 11. Starting at step s11.0, a simulated data transfer is performed (step s11.1, s11.2). For each simulation, a self-learning routine is performed (step s11.2) in order to obtain a set of optimised parameters. For instance, where the self-learning routine of step s11.2 corresponds to steps s6.1 to s6.4 or steps s6.1 to s6.7 of FIG. 6, a set of optimised parameters including para1, para2, the scaling factor and β may be obtained and stored within the memory 11 (step s11.3). A number of simulations may be performed (steps s11.4, s11.5, s11.2, s11.3) so that the bridge 3 can build up a knowledge base of optimised parameters for different packet types and/or different bridge pairings 3, 4. The training stage for that bridge 3 is then completed (step s11.6)

Each bridge 3 may perform its own self-training and compile its own knowledge base for storage in the memory 11. This teaching can be performed in a “training stage”, before the system is called upon to transfer real data. A bridge 3 within the bridging system can then consult this knowledge base to determine which connection setup would most suit the packet stream.

The knowledge base can be updated after the initial offline training stage in a number of ways. In one embodiment, the bridges 3, 4 can be taken offline and new training samples provided in order to teach the bridges 3, 4 to accommodate one or more new types of packet or link. Alternatively, or additionally, the bridges 3, 4 may be configured so that, when a packet first arrives and the optimum parameters cannot be obtained from the knowledge base, the receiving bridge 3 automatically optimises the parameters in a similar manner to that described in relation to FIG. 7. Information regarding the newly determined optimum arrangement can then be incorporated into the knowledge base.

Such a machine learning algorithm can allow parameters such as the number of connections 18-1 to 18-n, their addition, removal and use to be automated, reducing human interaction and supervision requirements.

Although the embodiments described above relate to a SAN, the invention can be used in other applications where data is transferred from one node to another. The invention can also be implemented in systems that use a protocol in which ACK messages are used to indicate successful data reception other than TCP/IP, such as those using Fibre Channel over Ethernet (FCOE), Internet Small Computer Systems Interface (iSCSI) or Network Attached Storage (NAS) technologies, standard Ethernet traffic or hybrid systems.

In addition, while the above described embodiments relate to systems in which data is acknowledged using ACK messages, the methods may be used in systems based on negative acknowledgement (NACK) messages. For instance, in FIG. 3, step s3.12, the processor 10 of the bridge 3 determines whether an ACK message has been received. In a NACK-based embodiment, the processor 10 may instead be arranged to determined whether a NACK message has been received during a predetermined period of time and, if not, to continue to data transfer using port i.

1. A method of transferring data from a first network node to a second network node, including:
obtaining initial values for one or more parameters pertaining to data transfer between the first node and the second node;
transferring data from the first node to the second node via one or more connections between the first node and the second node in accordance with said parameters; and
performing an adjustment routine to obtain updated values of the one or more parameters based on performance of the data transfer.

2. A method according to claim 1, wherein the one or more parameters include the number of connections used to transfer the data from the first node to the second node, the method including adjusting the number of connections between the first node and the second node according to the updated values.

3. A method according to claim 1, wherein said initial values are values obtained from a previous data transfer between the first and second nodes.

4. A method according to claim 1, wherein obtaining said initial values includes determining attributes of the data packets to be transferred and retrieving the initial values corresponding to said attributes from a database.

5. A method according to claim 3, including performing the adjustment routine for simulated data transfers between the first and second node for data packets having different attributes and compiling said database from the updated values obtained from said adjustment routine.

6. A method according to claim 1, wherein the one or more connections are TCP/IP connections and the one or more parameters include Receive Window Size.

7. A method according to claim 1, wherein the one or more parameters include network speed.

8. A method according to claim 1, wherein the one or mote parameters include loading of computing resources at the first or second node.

9. A method according to claim 4, including performing said simulation for a plurality of pairs of first and second nodes.

10. A node comprising arranged to transmit data packets to a destination node, including:
a processor arranged to obtain initial values for one or more parameters pertaining to data transfer between the node and the destination node and to control said data transfer; and
one or more ports for transferring data to the second node via one or more connections in accordance with said parameters;
wherein said processor is arranged to perform an adjustment routine to obtain updated values of the one or more parameters based on performance of the data transfer.

11. A node according to claim 10, wherein:
the one or more parameters include the number of connections used to transfer the data from the first node to the second node; and
the processor is arranged to adjust the number of connections between the first node and the second node according to the updated values

12. A node according to claim 10, including:
a memory arranged to store values of said one or more parameters obtained from a previous data transfer between the node and said destination node;
wherein said processor is arranged to obtain said initial values by retrieving said stored values from said memory.

13. A node according to claim 10, including a memory, wherein the processor is arranged to obtain said initial values by determining attributes of the data packets to be transferred and retrieving said initial values corresponding to said attributes from a database stored in said memory.

14. A node according to claim 13, wherein the processor is arranged to compile said database from simulated data transfers between the node and the destination node for data packets having different attributes, the processor being arranged to store the updated values obtained from said adjustment routine.

15. A node according to claim 13, wherein said database includes values obtained from simulated data transfers between the node and a plurality of destination nodes.

16. A node according to claim 10, wherein said one or more ports are configured to transmit data via one or more TCP/IP connections and the one or more parameters include a Receive Window Size.

17. A node according to claim 10, wherein the one or more parameters include network speed.

18. A node according to claim 10, wherein the one or more parameters include loading of computing resources at the first or second node.

19. A method of transmitting a plurality of related data packets from a first node to a second node, including:
(a) configuring a plurality of connections at the first node;
(b) transmitting a first batch of said data packets from the first node to the second node using a first one of said connections;
(c) transmitting a second batch of said data packets from the first node to the second node using a second one of said connections; and
(d) determining whether said first batch has been received by said second node based on whether a message relating to the first batch has been received from the second node;
wherein said transmission of the second batch is initiated before said determination is made.

20. A method according to claim 20, including:
(e) after determining whether said first batch has been received by said second node, transmitting a third batch of said data packets using said first connection;
(f) determining whether said second batch has been received by said second node, based on whether a message relating to the second batch has been received from the second node; and
(g) transmitting a fourth batch of said data packets from the first node to the second node using said second connection after determining whether said second batch has been received by said second node but without determining whether said third batch has been received by said second node.

21. A method according to claim 19, wherein said message from the second node is an acknowledgement message indicating receipt of said first batch.

22. A method according to claim 19, wherein said message from the second node is a negative acknowledgement message indicating that said first batch has not been received.

23. A method according to claim 20, wherein a cycle including steps (d) to (g) is performed repeatedly.

24. A method according to claim 23, wherein each of said cycles includes transmitting batches of said data packets using two or more of said plurality of connections in a sequence.

25. A method according to claim 24, including:
monitoring a rate of transfer of said batches between the first node and the second node; and
adjusting the number of ports in said sequence according to said transfer rate.

26. A node arranged to transmit a plurality of related data packets to a destination node, including:
a transmitter operable to transmit to the destination node data packets having one of a plurality of assigned port numbers;
a receiver operable to receive messages from the destination node;
wherein the node is operable to:
transmit a first batch of said data packets using a first one of said port numbers; and
transmit a second batch of said data packets from the first node to
the second node using a second one of said port numbers before determining whether said first batch has been received by the destination node, said determination being based on whether a first message, relating to said first batch, has been received from the destination node.

27. A node according to claim 26, wherein the transmitter is operable to:
transmit a third batch of said data packets to the destination node using said first port number, in response to a determination that said first batch has been received by the receiver; and
transmit a fourth batch of said data packets to the destination node using said second port number in response to a determination that said second batch has been received by the receiver but before determining whether said third batch has been received by the receiver.

28. A node according to claim 26, wherein the transmitter is operable to transmit batches of said data packets using two or more of said plurality of port numbers in a sequence repeatedly.

29. A node according to claim 28, including a processor arranged to monitor a data transfer rate between the node and the destination node and to adjust the number of port numbers in said sequence according to said data transfer rate.

30. A system including:
a node according to claim 10; and
said destination node;
wherein said destination node comprises a data storage facility.

31. A system including:
a node according to claim 26; and
said destination node;
wherein said destination node includes a data storage facility.

32. A computer program including instructions which, when executed by a processor, causes a node to perform a method according to claim 1.

33. A computer program including instructions which, when executed by a processor, causes a node to perform a method according to claim 19.

34. A computer readable medium on which is stored a computer program according to claim 32.

35. A computer readable medium on which is stored a computer program according to claim 33.
